(19) United States
(12) Patent Application Publication
(10) Pub. No.: US 2022/0392320 A1
(43) Pub. Date: Dec. 8, 2022

(54) TACTILE PRESENTATION DEVICE AND TACTILE PRESENTATION METHOD

(71) Applicant: KABUSHIKI KAISHA TOKAI RIKA DENKI SEISAKUSHO, Aichi (JP)

(72) Inventors: Takeshi OHNISHI, Aichi (JP); Yuma NAKAI, Aichi (JP)

(73) Assignee: KABUSHIKI KAISHA TOKAI RIKA DENKI SEISAKUSHO, Aichi (JP)

(21) Appl. No.: 17/778,019

(22) PCT Filed: Dec. 23, 2020
(86) PCT No.: PCT/JP2020/048165

§ 371 Date: May 19, 2022

(30) Foreign Application Priority Data
Dec. 25, 2019 (JP) 2019-234088

(51) Int. Cl. G08B 6/00

(52) U.S. Cl. CPC G08B 6/00

(57) ABSTRACT

Provided is a tactile presentation device that makes it possible to minimize discomfort by presenting a suitable tactile sensation. The tactile presentation device 1 is configured to be equipped with: an operation part having an operation member operated by a user; a tactile presentation part 3 for presenting a tactile sensation to the user via the operation member; an awareness determination unit 4 that determines whether the user is aware of at least one of the operation member and a display screen for displaying an operation target operated by the operation member; and a control unit 6 that controls the tactile presentation part 3 so as to adjust the intensity of the tactile sensation presented to the user in accordance with the determination result of the awareness determination unit 4.

### TECHNICAL FIELD

The invention relates to a tactile presentation device and a tactile presentation method.

### RELATED ART

As the conventional art, a tactile presentation device in which an annular piezoelectric element is fixed to a main surface on one side of a flexible plate-like member in which a main surface on the other side serves as an operation surface touched by an operator.

Such tactile presentation device notifies the operator with a tactile presentation through deflection of the plate-like member generated alongside the deformation of the annular piezoelectric element. The tactile presentation device can generate a sufficiently large displacement with respect to the operation surface, and can clearly acknowledge the operator of the reception of the operation.

### CITATION LIST

### Patent Literature

[Patent Literature 1] Japanese Laid-open No. 2019-169009

### SUMMARY OF INVENTION

### Technical Problem

In the conventional tactile presentation device, when the operator's awareness conforms to the fingertip making contact with the operation surface, it is possible that the significant displacement of the operation surface, that is, a strong tactile sensation, may bring discomfort to the operator.

Accordingly, an objective of the invention is to provide a tactile presentation device capable of suppressing the discomfort by presenting a suitable tactile sensation.

### Solution to Problem

An aspect of the invention provides a tactile presentation device. The tactile presentation device includes: an operation unit, having an operation member operated by a user; a tactile presentation unit, presenting a tactile sensation to the user via the operation member; an awareness determination unit, determining whether the user is aware of at least one of the operation member and a display screen for displaying an operation target operated by the operation member; and a control unit, controlling the tactile presentation unit so as to adjust an intensity of the tactile sensation presented to the user in accordance with a determination result of the awareness determination unit.

Another aspect of the invention provides a tactile presentation method for controlling a tactile presentation device. The tactile presentation device includes: an operation unit, having an operation member operated by a user; and a tactile presentation unit, presenting a tactile sensation to the user via the operation member. The tactile presentation method includes: an awareness determination step of determining whether the user is aware of at least one of the operation member and a display screen for displaying an operation target operated by the operation member; and a control step of controlling the tactile presentation unit so as to adjust an intensity of the tactile sensation presented to the user in accordance with a determination result of the awareness determination step.

Yet another aspect of the invention provides a tactile presentation method. The tactile presentation method includes: a step of detecting a sight line of a user from an operation in which the user operates an operation member; a step of monitoring whether the sight line intersects with an awareness region of the operation member; and a step of exerting control to: if the sight line of the user intersects with the awareness region, present a tactile sensation weaker than a tactile sensation in a case where an awareness of the user conforms; and if the sight line of the user does not intersect with the awareness region, present a tactile sensation stronger than a tactile sensation in a case where the awareness of the user does not conform.

### Effects of Invention

According to the invention, by presenting a suitable tactile sensation, the discomfort can be suppressed.

### BRIEF DESCRIPTION OF DRAWINGS

FIG. 1A is a diagram illustrating the inside of a vehicle in which an example of a tactile presentation device according to an embodiment is mounted, and FIG. 1B is a block diagram illustrating the tactile presentation device.

FIG. 2A is a side view illustrating an example of a configuration of a tactile presentation device according to an embodiment, FIG. 2B is a diagram illustrating a driving signal driving a voice coil motor of a tactile presentation unit, and FIG. 2C is a diagram illustrating an example of a driving signal driving a sound output unit of the tactile presentation unit.

FIG. 3A is a view illustrating an example of an eyeball for describing an example of a process for detecting a user's sight line in a tactile presentation device according to an embodiment, and

FIG. 3B is a diagram describing an example of a system for calculating an intersection point between sight line and an awareness region.

FIG. 4 is a flowchart illustrating an example of an operation of the tactile presentation device according to an embodiment.

FIG. 5 is a view illustrating an example of a configuration of a main display in which an awareness region of a tactile presentation device according to another embodiment is set.

### DESCRIPTION OF EMBODIMENTS

### Outline of Embodiments

A tactile presentation device according to the embodiments is schematically configured as including: an operation unit, having an operation member operated by a user; a tactile presentation unit, presenting a tactile sensation to the user via the operation member; an awareness determination unit, determining whether the user is aware of at least one of the operation member and a display screen for displaying an operation target operated by the operation member; and a control unit, controlling the tactile presentation unit so as to adjust the intensity of the tactile sensation presented to the user in accordance with the determination result of the awareness determination unit.

The tactile presentation device adjusts the intensity of the tactile sensation presented to the user in accordance with whether the user is aware of the operation member or the display screen. Therefore, compared with the case where the tactile presentation is constant regardless of awareness, the discomfort brought by the strong tactile sensation regardless of awareness can be suppressed.

### Embodiments

(Outline of Tactile Presentation Device 1)

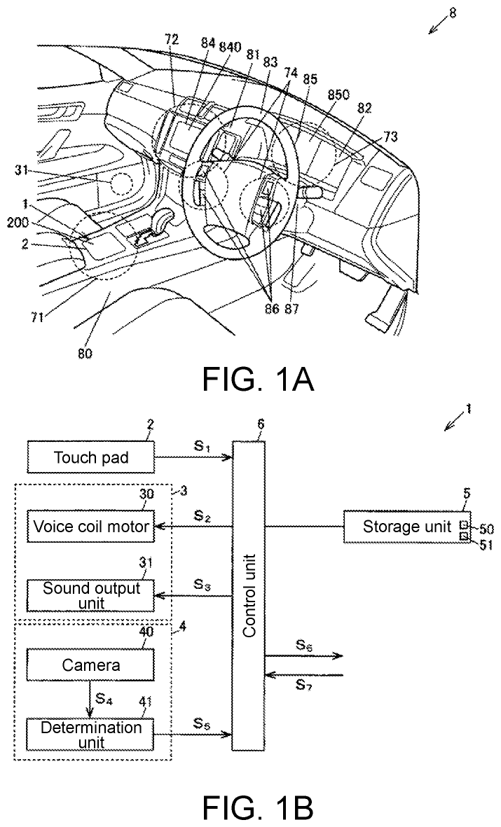

In the following, an example of a tactile presentation device according to the embodiment will be described with reference to the drawings. In the respective drawings according to the embodiment described in the following, the ratios between the figures may be different from the actual ratios. In addition, in FIG. 1B, the flow of main signals and information is indicated by using arrows.

The tactile presentation device 1 is configured to present a tactile feedback, that is, a tactile sensation, making the user recognize that an operation performed by the user is received. As an example, the tactile presentation device 1 according to the embodiment is electrically connected to an electronic apparatus mounted in a vehicle 8, and is configured to function as an operation device receiving an input of the information used for controlling the electronic apparatus. As an example, the electronic apparatus is a control device, etc., for comprehensively controlling an air conditioning device, a music and video playback device, a navigation device, and the vehicle 8.

When the tactile presentation device 1 is mounted in the vehicle 8, it may be difficult to recognize the tactile presentation presented to the user due to vibrations and sounds, etc., resulted from traveling, etc. However, when the tactile presentation device constantly presents a strong tactile sensation, although the user is aware of the presentation of the tactile sensation, the strong tactile sensation may bring discomfort when presented to the user. The tactile presentation device 1 according to the embodiment includes, as an example, a configuration as follows to present a suitable tactile sensation in accordance of the user's awareness.

As shown in FIGS. 1A and 1B, the tactile presentation device 1 is schematically configured as including: an operation unit, having an operation member operated by a user; a tactile presentation unit 3, presenting a tactile sensation to the user via the operation member; an awareness determination unit 4, determining whether the user is aware of at least one of the operation member and a display screen for displaying an operation target operated by the operation member; and a control unit 6, controlling the tactile presentation unit so as to adjust the intensity of the tactile sensation presented to the user in accordance with the determination result of the awareness determination unit.

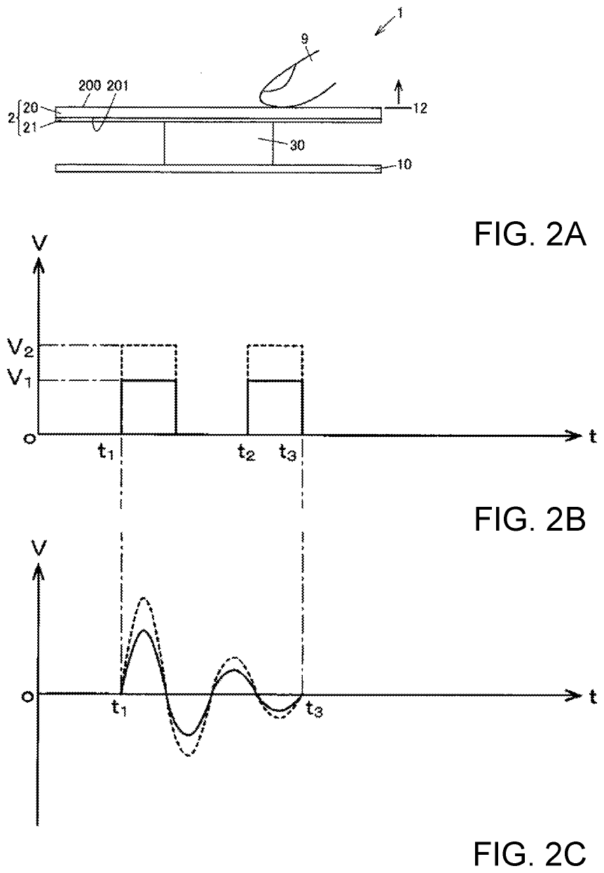

As shown in FIG. 2, the operation unit is a touch pad 2 including a panel 20 as the operation member and a detection unit 21 detecting a touch operation operated on an operation surface 200 as a front surface of the panel 20. A first region to be described in the following is set as a region including the operation surface 200 of the panel 20.

Although the tactile presentation device 1 presents a tactile sensation through vibration with respect to the operation member, the tactile presentation device 1 may further add at least one of a sound and light to present the tactile sensation. The tactile presentation unit 3 of the embodiment performs tactile presentation through making a sound in addition to applying vibration with respect to the operation member.

As shown in FIG. 1B, the tactile presentation device 1 includes the control unit 6 and a storage unit 5 electrically connected to the control unit 6. As an example, the storage unit 5 is a semiconductor memory provided together with the control unit 6 on a substrate. However, the invention is not limited thereto. The storage unit 5, for example, may also be a random access memory (RAM) included in the control unit 6 or an external storage device electrically connected to the control unit 6. The storage unit 5 stores an electrostatic threshold value 50 and a driving signal information 51.

As shown in FIG. 1A, the vehicle 8 includes, as a display device, a main display 84 arranged in a center console 81 and a sub-display 85 arranged in an instrument panel 82.

In the following, as an example, the tactile presentation in the case where the user operates the touch pad 2 as the operation unit, and operates an operation target such as a cursor or an icon displayed on a display screen 840 of the main display 84 as the display device is described.

However, the operation unit is not limited to the touch pad 2. For example, the operation unit may also be at least one of multiple steering switches 86 arranged on a steering 83 and receiving a push operation, etc., the main display 84 including a touch panel receiving a touch operation, and other mounted operation devices receiving a rotary operation, etc.

In addition, the display screen displaying the operation target is not limited to the display screen 840 of the main display 84. The display screen may also be at least one of the display screen 840 of the main display 84, a display screen 850 of the sub-display 85, a display screen of a multi-functional mobile phone or a tablet terminal wiredly or wirelessly connected to the vehicle 8, and a display screen of a display device mounted elsewhere, such as in a head-up display, and displaying the operation target on a front glass, etc.

(Configuration of Touch Pad 2)

The touch pad 2 is a touch pad detecting a touched location on the operation surface 200 through being touched on the operation surface by a body portion (e.g., finger) of the user's body or a dedicated pen. Through performing an operation on the operation surface 200, it is possible for the user to operate the electronic apparatus that is connected. As the touch pad 2, a touch pad of a resistance film type, an infrared type, a surface acoustic wave (SAW) type, a capacitance type, etc., can be used.

In the embodiment, the touch pad 2 is a touch pad of the capacitance type, and is able to detect a tracing operation, a touch operation, a multi-touch operation, and a gesture operation, etc.

The touch pad 2, as shown in FIG. 1A, is arranged in a floor console 80 located between the driver's seat and the passenger's seat of the vehicle 8, and the operation surface 200 is exposed. A Cartesian coordinate system is set in the operation surface 200.

As shown in FIG. 2A, the touch pad 2 is schematically configured to include the panel 20 and the detection unit 21.

As shown in FIG. 2A, the panel 20 has a plate shape. As an example, the panel 20 is formed by a resin material, such as polycarbonate, or glass, etc. In the touch pad 2, a film, etc., may also be arranged on the front surface of the panel 20.

As shown in FIG. 2A, the detection unit 21 is arranged on a back surface 201 of the panel 20 and integrated with the panel 20. The detection unit 21 is arranged so that multiple driving electrodes and multiple detection electrodes intersect with each other while being insulated from each other. The detection unit 21 reads the capacitance generated between the driving electrodes and the detection electrodes in all combinations. Also, the detection unit 21 outputs the information of the capacitance that is read, as a detection information S₁, to the control unit 6.

As a modified example, the touch pad 2 may also be configured as including an electrostatic control unit calculating the coordinates under operation. In such case, the touch pad 2 generates the detection information S₁ including the coordinates where the operation is detected and outputs the detection information S₁ to the control unit 6.

(Configuration of Tactile Presentation Unit 3)

The tactile presentation unit 3 presents a tactile sensation by applying vibration to the panel 20 of the touch pad 2 and outputting a sound in association with the vibration. The tactile presentation unit 3 presents the vibration by using an actuator, such as a voice coil motor or a piezoelectric element. The tactile presentation unit 3 of the embodiment, as an example, includes a voice coil motor 30 applying vibration to the panel 20 and a sound output unit 31 outputting a sound.

As a modified example, the tactile presentation unit 3 may also output a sound together with vibration due to the vibration of the panel 20. In this case, the driving signal output from the control unit 6 is a signal in which a signal for generating a sound is superimposed with a signal for generating vibration.

The voice coil motor 30, as shown in FIG. 2A, is arranged between a base 10 and the panel 20 of the tactile presentation device 1. The voice coil motor 30 drives the panel 20 upward from a reference position 12 with the operation surface 200 set as reference, and provides a tactile feedback to the user via an operation finger 9.

The sound output unit 31, as shown in FIG. 1A, is configured to include multiple speakers arranged in doors, pillars, etc., of the vehicle 8. However, the sound output unit 31 is not limited thereto, but may also be arranged in the vicinity of the operation member whose tactile sensation is presented through vibration.

FIGS. 2B and 2C illustrate the graphs of a driving signal S₂ and a driving signal S₃. The vertical axes of FIGS. 2B and 2C represent voltage (V), and the horizontal axes thereof represent time (t). FIG. 2B illustrates an example of the driving signal S₂ driving the voice coil motor 30. As an example, the driving signal S₂ is a signal presenting the tactile feedback of vibration between a time t₁ to a time t₃, and is a signal that pushes the panel 20 upward twice from the reference position 12 with two pulse signals. The pulse signals are presented at the time t₁ and a time t₂.

In addition, FIG. 2C illustrates an example of the driving signal S₃ driving the sound output unit 31. As an example, the driving signal S₃ is a signal which starts a sound output at the time t₁ together with the initial vibration presentation and is attenuated until the time t₃.

The driving signal S₂ indicated in a solid line in FIG. 2B is a driving signal when the user's awareness conforms to a region including the panel 20 of the touch pad 2 or the display screen 840 of the main display 84. The driving signal S₂ is configured from two pulse signals in which the voltage is V₁.

The driving signal S₂ indicated in a dotted line in FIG. 2B is a driving signal when the user's awareness does not conform to the region including the panel 20 of the touch pad 2 or the display screen 840 of the main display 84. The driving signal S₂ is configured from two pulse signals in which the voltage is V₂. In order to present a stronger tactile sensation to the user, the driving signal S₂ when the user's awareness does not conform is a driving signal with the voltage V₂ that is α times (0<α) the voltage V₁.

The driving signal S₃ indicated in a solid line in FIG. 2C is a driving signal when the user's awareness conforms to the region including the panel 20 of the touch pad 2 or the display screen 840 of the main display 84.

The driving signal S₃ indicated in a dotted line in FIG. 2C is a driving signal when the user's awareness does not conform to the region including the panel 20 of the touch pad 2 or the display screen 840 of the main display 84. In order to present a sound in association with the stronger tactile sensation to the user, the driving signal S₃ when the user's awareness does not conform is a driving signal that is β times (0<β) the driving signal S₃ when the awareness conforms.

As an example, the driving signals S₂ and the driving signals S₃ when the user's awareness conforms and when the user's awareness does not conform are stored as the driving signal information 51 stored in the storage unit 5. The driving signal information 51 may be information of the waveforms of the driving signals, and may also be information of functions for generating the driving signals. The invention is not particularly limited in this regard.

In the case where the driving signal S₂ and the driving signal S₃ are functions, when the awareness is determined as not conforming, the control unit 6 multiplies the signals when the awareness conforms by α times and β times based on the driving signal information 51 to generate the driving signal S₂ and the driving signal S₃.

As an example, the driving signal S₂ and the driving signal S₃ are signals whose signal amplitudes differ when the user's awareness conforms and when the user's awareness does not conform. However, the invention is not limited thereto. The driving signal S₂ and the driving signal S₃ may also have different vibration patterns and sound output patterns, such as timings or numbers of times, when the user's awareness conforms and when the user's awareness does not conform, and may also have different amplitudes in addition to different vibration patterns and sound output patterns.

(Configuration of Awareness Determination Unit 4)

In the case where one of the first region determined in advance and including the operation member and a second region determined in advance and including the display screen intersects with the user's sight line, the awareness determination unit 4 determines that the user is aware.

As shown in a dotted line in FIG. 1A, the first region is an awareness region 71 including the operation surface 200 of the touch pad 2. In addition, the second region is an awareness region 72 including the display screen 840 of the main display 84. The awareness region 71 and the awareness region 72 are determined in advance to include the operation surface 200 and the display screen 840 viewed from the user seated at the driver's seat. The awareness region 71 and the awareness region 72 are, for example, determined through simulation or experimentation.

As a modified example, the first region may also be an awareness region 74 including the steering switch 86 arranged in the steering 83 on which an operation is detected. In addition, the first region may also be another awareness region including an operation member under operation, such as a switch or a touch pad presenting a tactile sensation other than the above.

When multiple first regions are set as regions including operation members operable by the user, even if a first region including an operation member not under operation intersects with the sight line, the awareness determination unit 4 still determines that the user's awareness does not conform.

As a modified example, the second region may also be an awareness region 73 including the display screen 850 of the sub-display 85 as the display screen. In addition, the second region may also be another awareness region including a display screen of a head-up display, etc., displaying an operation target other than the above.

As shown in FIG. 1B, the awareness determination unit 4 includes a camera 40, a determination unit 41, and an illumination unit 42. The camera 40 is arranged on the ceiling, a steering column 87, etc., of the vehicle 8 to be able to capture an image of the user's face. The illumination unit 42 verifies the user's face with near infrared light at the time of capturing an image. Also, the camera 40 periodically captures the user's image, and outputs an image information S₄, which is the information of the captured image, to the determination unit 41. As a modified example, the awareness determination unit 4 may also be configured to detect the user's sight line by using an infrared sensor, etc.

The determination unit 41 is a micro-computer formed by a central processing unit (CPU) calculating, processing, etc., the obtained data according to a stored program, and a RAM and a read-only memory (ROM), etc., which are semiconductor memories.

As an example, the determination unit according to the embodiment detects the sight line by adopting a process using a Purkinje image 92. In the following, an awareness region 7 representing the first region or the second region is adopted as an example, and the detection of the intersection between the user's sight line 93 and the awareness region 7 is described.

The determination unit 41 is configured to irradiate an eyeball 90 with a near infrared beam from the illumination unit 42, and calculate an intersection point 94 that is an intersection point between the sight line 93 and the awareness region 7. The slight line 93 is from the reflected light (Purkinje image 92) on the surface of the cornea and the location of a pupil 91, and the awareness region 7 includes the operation member. The area of the awareness region 7 may be set to an extent that the processing speed of the awareness determination unit 4 does not drop significantly.

Specifically, the determination unit 41 segments an image 43 captured by the camera 40 into regions of similar brightness, and determines, from region shapes, a pupil region from the respective segmented regions by using a pattern matching process, etc. An example of a process for determining the pupil region by pattern matching includes a process of assuming that the pupil is elliptical and specifying the elliptical region from the image.

Also, the determination unit 41 performs ellipse approximation based on the minimum error squared sum with respect to a contour set of the pupil 91 to obtain the ellipse center.

Also, the determination unit 41 detects the Purkinje image 92 as a target within a predetermined range from the obtained ellipse center. The center coordinates of the Purkinje image 92 are the gravity center of the obtained region.

Also, the determination unit 41 calculates the sight line 93 from the pupil 91 and the Purkinje image 92 that are obtained. In the following, the calculation is described.

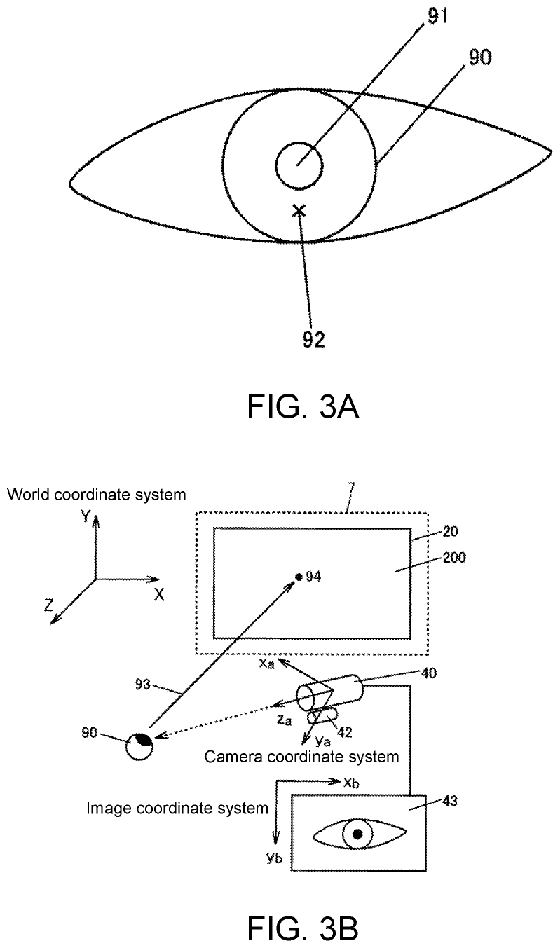

The coordinates in the image coordinate system (X_{b}Y_{b} coordinate system) shown in FIG. 3B can be converted into the coordinates of the world coordinate system (XYZ coordinate system) when Z coordinates in the world coordinate system are already known, for example. In addition, the cornea curvature center is obtained from the Purkinje image 92 in the camera coordinate system (xₐyₐzₐ coordinate system).

Also, the determination unit 41 calculates the coordinates of the pupil center as the cornea curvature center in the camera coordinate system, and converts the respective coordinates into coordinates of the world coordinate system to obtain a sight line vector in the world coordinate system. When the sight line vector intersects with the awareness region 7 at the intersection point 94, the determination unit 41 determines that the user's awareness conforms to the awareness region 7. However, the process for detecting the sight line is not limited to the above example, and it is possible to apply a process such as calculating the intersection point 94 from the eye position or the rotation angle of the face, etc.

Although the determination unit 41 determines that the user's awareness conforms when the sight line 93 intersects with the awareness region 7, the invention is not limited thereto. The determination unit 41 may also determine that the user's awareness conforms when the user's face conforms to the direction of the awareness region 7.

The determination unit 41 generates an awareness information S₅ indicating whether the user's awareness conforms to the awareness region 71 or the awareness region 72 and outputs the awareness information S₅ to the control unit 6.

(Configuration of Control Unit 6)

The control unit 6 is a micro-computer formed by a CPU calculating and processing the obtained data according to a stored program, and a RAM and a ROM, etc., which are semiconductor memories. The ROM, for example, stores a program for operating the control unit 6. The RAM, for example, is used as a storage region temporarily storing a computation result. In addition, the control unit 6 is provided inside with a means for generating a clock signal, and operates based on the clock signal.

The control unit 6 calculates the coordinates at which the operation is detected based on the detection information S₁ periodically obtained from the touch pad 2 and the electrostatic threshold value 50 stored in the storage unit 5. As an example, the coordinates are calculated by using weighted average. However, the invention is not limited thereto. The location of the gravity center may also be set as the coordinates at which the operation is detected.

The control unit 6, for example, can perform detection on whether a contact is made to the operation unit, specification of the operation coordinates, and specification of the operation mode. Regarding the detection on whether a contact is made to the operation unit, when the detection value of the touch pad 2 as the operation unit is equal to or greater than a predetermined threshold Th (electrostatic threshold value 50), the control unit 6 determines that there is a contact. In addition, the control unit 6 specify the gravity center of the region in which the detection value is equal to or greater than the threshold Th as the operation coordinates.

When the trajectory of the operation coordinates continues through time, the control unit 6 determines the operation as a tracing operation, and when the presence and absence of a contact to the operation unit is detected, the control unit 6 determines the operation as a touch operation. In addition, when the presence and absence of a contact to the operation unit is detected at two or more places separated from each other, the control unit 6 determines that the operation is a multi-touch operation. In addition, when the trajectory of the operation coordinates is associated with the user's behavior and specified, the control unit 6 can determine the operation as a gesture operation. For example, along the trajectory of a region in which the detection value is equal to or greater than the predetermined threshold through time, the control unit 6 can specify whether the user performs a wipe operation. Accordingly, the control unit 6 can specify various operation modes with respect to the operation unit.

When the user is aware of at least one of the panel 20 and the display screen 840, the control unit 6 sets the intensity of the tactile sensation to be relatively weaker than the intensity when the user is not aware. That is, when the user is aware of at least one of the awareness region 71 (first region) including the panel 20 and the awareness region 72 (second region) including the display screen 840, the control unit 6 sets the intensity of the tactile sensation to be relatively weaker than the intensity when the user is not aware.

Setting the intensity of the tactile sensation to be relatively weaker may be a process of reducing the intensity of the tactile sensation at the time of being aware to be weaker than the intensity when not aware as well as a process of increasing the intensity of the tactile sensation at the time of being not aware to be stronger than the intensity of being aware. In the embodiment, as shown in FIGS. 2B and 2C, in the case of being not aware, the intensity of the tactile sensation increased with respect to the case of being aware.

The control unit 6 generates an operation information S₆ including the information of the coordinates at which the operation is detected based on the detection information S₁ output from the touch pad 2, and outputs the operation information S₆ to the electronic apparatus that is electrically connected. The electronic apparatus obtains the operation information S₆, and, when it is necessary to present the tensile sensation, outputs an instruction signal S₇ to the control unit 6. The control unit 6 confirms the user's awareness based on the input of the instruction signal S₇, and presents a suitable tactile sensation in accordance with whether the user's awareness conforms or not.

The control unit 6 is not limited to presenting the touch sensation according to the input of the instruction signal S₇, but may also be configured to determine whether to present the tactile sensation in accordance with the operation of the control unit 6.

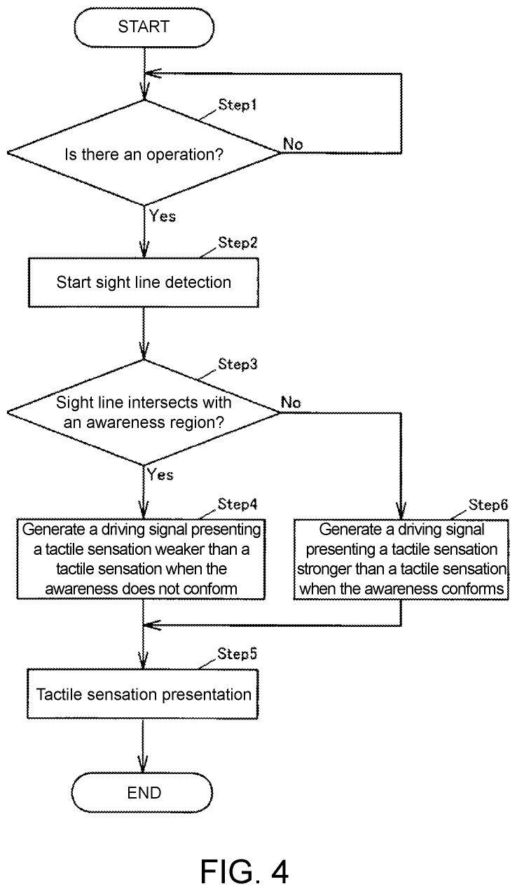

In the following, an example of the operation of the tactile presentation device 1 according to the embodiment is described in accordance with the flowchart of FIG. 4. Here, the case of presenting the tactile sensation in accordance with the operation that is operated is described as an example.

(Operation)

When the power of the vehicle 8 is turned on, the control unit 6 of the tactile presentation device 1 monitors whether an operation is performed based on the detection information S₁ periodically output from the touch pad 2. When “Yes” in Step1 (Step1: Yes), the control unit 6 generates the operation information S₆ based on the operation that is operated, and outputs the operation information S₆ to the electronic apparatus. Also, when obtaining the instruction signal S₇ from the electronic apparatus, the control unit 6 controls the awareness determination unit 4 to detect the sight line (Step2).

When the user's sight line 93 intersects with the awareness region 71 or the awareness region 72 based on the awareness information S₅ output from the awareness determination unit 4, that is, when the user's awareness conforms to the panel 20 or the display screen 840 (Step3: Yes), the control unit 6 generates the driving signal S₂ and the driving signal S₃ presenting a tactile sensation weaker than the tactile sensation when the user's awareness does not conform (Step4).

The control unit 6 outputs the driving signal S₂ and the driving signal S₃ that are generated to the tactile presentation unit 3 to present the tactile sensation (Step5), and the operation relating to tactile presentation is ended.

In Step3, when the user's sight line 93 does not intersect with any of the awareness region 71 and the awareness region 72, that is, when the user's awareness does not conform to any of the panel 20 and the display screen 840 (Step3: No), the control unit 6 generates the driving signal S₂ and the driving signal S₃ presenting a tactile sensation stronger than the tactile sensation when the user's awareness conforms (Step6), and presents the tactile sensation (Step5).

### Effects of Embodiments

The tactile presentation device 1 according to the embodiment can suppress the discomfort by presenting a suitable tactile sensation. Specifically, the tactile presentation device 1 adjusts the intensity of the tactile sensation presented to the user in accordance with whether the user is aware of the panel 20 on which an operation is performed or the display screen 840 displaying the operation target. Therefore, compared with the case where a constant tactile sensation is presented regardless of awareness, a suitable tactile sensation can be presented to suppress the discomfort resulting from the strong tactile sensation.

When the user's sight line 93 does not conform to the awareness region 71 or the awareness region 72, the tactile presentation device 1 increases the intensity of the tactile sensation presentation together with a sound, and that the operation performed without the user watching the awareness region 71 or the awareness region 72 has been received can be clearly presented. In addition, in the case where the user's sight line 93 conforms to the awareness region 71 or the awareness region 72, the tactile presentation device 1 can lower the intensity of the tactile sensation together with a sound to suppress the discomfort.

When the user's sight line 93 intersects with the awareness region 71 including the panel 20 or the awareness region 72 including the display screen 840, the tactile presentation device 1 determines that the user's awareness conforms to the panel 20 or the display screen 840. Therefore, compared with the case where such configuration is not adopted, the configuration can present a more suitable tactile sensation in accordance with the user's awareness to suppress the discomfort.

The tactile presentation device 1 weakens the tactile sensation not only when the operation finger 9 contacts the panel 20, but also when the user watches the display screen 840 displaying the operation target. Therefore, compared with the case where such configuration is not adopted, the configuration can present a more suitable tactile sensation to suppress the discomfort.

When presenting the tactile sensation by adding a sound together with the vibration of the panel 20, the tactile presentation device 1 adjusts the intensity of the sound in addition to the vibration according to the user's awareness. Therefore, compared with the case where such configuration is not adopted, the configuration can suppress the discomfort when a loud sound is output even though the user is aware.

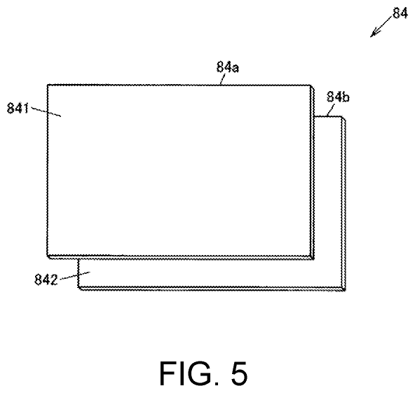

Here, as another embodiment, as shown in FIG. 5, in the operation unit of the tactile presentation device 1, a touch panel 84a as the operation member receiving the touch operation operated on an operation surface 841 is arranged to be overlapped with a display unit 84b having a display screen 842. When a region determined in advance and including the operation surface 841 intersects with the user's sight line, the awareness determination unit 4 determines that the user is aware.

In the embodiment, the main display 84 includes the touch panel 84a. Accordingly, the first region including the operation member and the second region including the display screen form one region. That is, the region determined in advance and including the operation surface 841 becomes the awareness region 72 of FIG. 1(A). When the user's sight line 93 intersects with the awareness region 72, the awareness determination unit 4 determines that the user's awareness conforms.

According to the tactile presentation device 1 according to at least one of the embodiments, it is possible to suppress the discomfort by presenting a suitable tactile sensation.

Depending on the purpose, a portion of the tactile presentation device 1 according to the embodiments and the modified examples may be realized by an application specific integrated circuit (ASIC) and a field programmable gate array (FPGA), etc., for example.

Although some embodiments and modifications of the invention have been described above, the embodiments and modifications are merely examples and do not limit the invention according to the claims. The novel embodiments and modifications can be implemented in various other embodiments, and various omissions, replacements, changes, etc., can be made without departing from the gist of the invention. Moreover, not all of the combinations of features described in the embodiments and modifications are essential for the means for solving the problems of the invention. Further, the embodiments and modifications are included in the scope and gist of the invention, and are included in the scope of the invention described in the claims and the equivalent scope thereof.

### REFERENCE SIGNS LIST

1: Tactile presentation device; 2: Touch pad; 3: Tactile presentation unit; 4: Awareness determination unit; 5: Storage unit; 6: Control unit; 7: Awareness region; 8: Vehicle; 9: Operation finger; 10: Base; 12: Reference position; 20: Panel; 21: Detection unit; 30: Voice coil motor; 31: Sound output unit; 40: Camera; 41: Determination unit; 42: Illumination unit; 43: Image; 50: Electrostatic threshold value; 51: Driving signal information; 71 to 74: Awareness region; 80: Floor console; 81: Center console; 82: Instrument panel; 83: Steering; 84: Main display; 84a: Touch panel; 84b: Display unit; 85: Sub-display; 86: Steering switch; 87: Steering column; 90: Eyeball; 91: Pupil; 92: Purkinje image; 93: Sight line; 94: Intersection point; 200: Operation surface; 201: Back surface; 840: Display screen; 841: Operation surface; 842: Display screen; 850: Display screen.

1. A tactile presentation device, comprising:
an operation unit, having an operation member operated by a user;
a tactile presentation unit, presenting a tactile sensation to the user via the operation member;
an awareness determination unit, determining whether the user is aware of at least one of the operation member and a display screen for displaying an operation target operated by the operation member; and
a control unit, controlling the tactile presentation unit so as to adjust an intensity of the tactile sensation presented to the user in accordance with a determination result of the awareness determination unit.

2. The tactile presentation device as claimed in claim 1, wherein when the user is aware of at least one of the operation member and the display screen, the control unit sets the intensity of the tactile sensation to be relatively weaker than an intensity when the user is not aware.

3. The tactile presentation device as claimed in claim 1, wherein the awareness determination unit determines that the user is aware when one of a first region determined in advance and comprising the operation member and a second region determined in advance and comprising the display screen intersects with a sight line of the user.

4. The tactile presentation device as claimed in claim 3, wherein the operation unit is a touch pad comprising a panel as the operation member and a detection unit detecting a touch operation operated on a front surface of the panel, and
the first region is set as a region comprising the front surface of the panel.

5. The tactile presentation device as claimed in claim 1, wherein in the operation unit, a touch panel, as the operation member receiving a touch operation operated on an operation surface, is arranged to be overlapped with a display unit having the display screen, and
when a region determined in advance and comprising the operation surface intersects with a sight line of the user, the awareness determination unit determines that the user is aware.

6. A tactile presentation method, which controls a tactile presentation device comprising: an operation unit, having an operation member operated by a user; and a tactile presentation unit, presenting a tactile sensation to the user via the operation member, the tactile presentation method comprising:
an awareness determination step of determining whether the user is aware of at least one of the operation member and a display screen for displaying an operation target operated by the operation member; and
a control step of controlling the tactile presentation unit so as to adjust an intensity of the tactile sensation presented to the user in accordance with a determination result of the awareness determination step.

7. The tactile presentation method as claimed in claim 6, wherein in the control step, when the user is aware of at least one of the operation member and the display screen, the intensity of the tactile sensation is set to be relatively weaker than an intensity when the user is not aware.

8. The tactile presentation method as claimed in claim 6, wherein in the awareness determination step, the user is determined as being aware when one of a first region determined in advance and comprising the operation member and a second region determined in advance and comprising the display screen intersects with a sight line of the user.

9. A tactile presentation method, comprising:
a step of detecting a sight line of a user from an operation in which the user operates an operation member;
a step of monitoring whether the sight line intersects with an awareness region of the operation member; and
a step of exerting control to: if the sight line of the user intersects with the awareness region, present a tactile sensation weaker than a tactile sensation in a case where an awareness of the user does not conform; and if the sight line of the user does not intersect with the awareness region, present a tactile sensation stronger than a tactile sensation when the awareness of the user conforms.

10. The tactile presentation device as claimed in claim 2, wherein the awareness determination unit determines that the user is aware when one of a first region determined in advance and comprising the operation member and a second region determined in advance and comprising the display screen intersects with a sight line of the user.

11. The tactile presentation device as claimed in claim 2, wherein in the operation unit, a touch panel, as the operation member receiving a touch operation operated on an operation surface, is arranged to be overlapped with a display unit having the display screen, and
when a region determined in advance and comprising the operation surface intersects with a sight line of the user, the awareness determination unit determines that the user is aware.

12. The tactile presentation method as claimed in claim 7, wherein in the awareness determination step, the user is determined as being aware when one of a first region determined in advance and comprising the operation member and a second region determined in advance and comprising the display screen intersects with a sight line of the user.
